(19) United States
(12) Patent Application Publication
(10) Pub. No.: US 2002/0073322 A1
(43) Pub. Date: Jun. 13, 2002

(54) Countermeasure against denial-of-service attack on authentication protocols using public key encryption

(76) Inventors: Dong-Gook Park, Seoul (KR); Jung-Joon Kim, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/752,668

(22) Filed: Dec. 28, 2000

(30) Foreign Application Priority Data
Dec. 7, 2000 (KR) 2000-74284

(51) Int. Cl. H04L 9/00

(52) U.S. Cl. 713/188

(57) ABSTRACT

The present invention gives robustness for the denial-of-service to the authentication protocol itself, loads no additional public key computation, and is applicable to any authentication protocol in which the client authenticates the server by sending the client's random number encrypted under the public key of the server. The method for defeating a denial-of-service attack for use in a communication system in which the client sends a ciphertext of a random number chosen by the client encrypted under a public key of the server to authenticate the server includes the steps of: (a) the server's generating a random number r_{B} in response to a service request from the client and sending the random number to the client; (b) the server's receiving the ciphertext which the client produced by using the random number r_{B} from the client and a random number r_{A} of the client; (c) the server's recovering a random number r_{B} from the ciphertext received from the client and comparing the recovered random number with the random number sent to the client; and (d) if the random numbers match at the step (c), providing the service, and, otherwise, denying the service.

### FIELD OF THE INVENTION

The present invention relates to a method for defeating denial-of-service attack on authentication protocols using public key encryption for a server-to-client authentication and a computer readable medium for recording a program implementing the method.

### PRIOR ART OF THE INVENTION

In a communication through a computer network, a client authenticates a server using an encryption of a random number with the server's public encryption key while the authentication of the client by the server may adopt any technique. The successful decryption of the random number by the server with the corresponding private key and its demonstration guarantees the client that the server is the authentic server. Among examples of such a server authentication are the Internet security protocol SSL/TLS (Secure Socket Layer/Transport Layer Security) and the authentication and key agreement protocol of the personal access communication system(PACS), one or the six personal communication system (PCS) standards in North America.

As Internet services have been used in more aspects of human life, a denial-of-service attack is becoming a growing concern. The denial-of-service attack is one of the most malicious Internet-based attack. Many things in human life, turned out to have their counterpart in the Internet world. The denial-of-service attack would be one example of them.

The denial-of-service attack is an attack in which an attacker seeks to initiate and leave unresolved a large number of connection requests to a Web server exhausting its resources and rendering it incapable of servicing legitimate connection requests from other clients.

SYN flooding attack in TCP/IP networks is the most well known example of this attack. The SYN flooding attack exploits a weakness in a TCP connection establishment protocol. The typical procedure of the TCP connection establishment is as follows.

At first, the client (system) sends the server a SYN message. In response, the server ends a SYN-ACK message to the client (system) and prepares the corresponding session by allocating buffer space. The client (system) then finishes establishing the connection by responding with an ACK message. After this sequence, the client (system) can exchange the service-specific data with the server.

However, the attacker does not follow the above sequence of messages. That, is, the attacker fails on purpose to send the third message, i.e., the SYN-ACK message, to the server. Accordingly, the session is left half-open until time out. Furthermore, the attacker may initiate large amounts of SYN messages simultaneously to the server, causing the server to be unable to handle the legitimate connection requests from other clients (system).

Using authentication protocol in the Internet environment is rather orthogonal to denial-of-service attacks. In other words, the authentication protocols themselves do not help prevent denial-of-service attacks, instead may give rise to another room for denial-of-service attacks due to computation load required to execute the authentication protocol.

Although the notorious SYN floodinging attacks can be minimized through careful design and operation of the Internet communication systems, the authentication protocols could be another door to similar denial-of-service attacks.

On the other hand, there has recently been introduced a cryptographic countermeasure against denial-of-service attack.

The cryptographic countermeasure is a new issue, of which the examples are “formal treatment of the attack”, “stateless protocol approach to mare security protocol more robust against the attack”, and “client puzzle” which enforces a predetermined amount of computations on attackers to mitigate the attack.

However, the client puzzle method should be implemented separately from the authentication protocol and furthermore requires overhead of computations on both the client and the server.

To authenticate the server with any cryptographic challenge-response mechanism, the client chooses a random number and sends it to the server. According to the way this random number is handled, the authentication methods may be categorized into two different methods.

The first is that the client (system) can send the random number in the clear and then the server signs over the random number with its own certified private key to generate electronic signature data to transfer to the client (system). The corresponding public verification key is available publicly and therefore the client can check whether the signature was generated by and came from the server. Successful checkings provides the authenticity of the server's identity.

The second alternative is to encrypt the random number using the public encryption key of the server before delivery from the client (system) to the server. The authentic server is then the only entity to be able to retrieve the random number from the ciphertext. The server decrypts the ciphertext using its private decryption key and then transfers the decrypted random number to the client (system). The client checks whether the decrypted random number from the server match the random number delivered to the server. If both numbers match, the server's identity in authenticated.

Each of the above two methods has its own strength and weakness. As far as denial-of-service attack is concerned, however, the latter method, i.e., random number encryption, is preferable. This is because in the latter method the random number from the client is not just a random number but an encrypted message thereof, which may be exploited to accommodate a countermeasure against denial-of-service attacks.

### SUMMARY OF THE INVENTION

Therefore, it is an object of the present invention to provide a method for defeating denial-of-service, applicable to any authentication protocols which adopts public key based encryption to authenticate the server to the client and excluding overhead of public key-related computations and a computer readable medium for recording a program implementing the method.

In accordance with an aspect of the present invention, there is provided a method for defeating a denial-of-service attack, for use in a communication system in which the client authenticates the server by sending encryption of a random challenge number under the public encryption key of the server, the method including the steps of: (a) generating a random number r_{B} in response to a request for a service from a client and sending the random number to the client; (b) receiving, from the client, the ciphertext produced by using the random number r_{B} sent to the client and a random number r_{A} chosen by the client; (c) recovering a random number r_{B} from the ciphertext received from the client and comparing the recovered random number with the random number sent to the client; and (d) if the random numbers match at the step (c), providing the service, and, otherwise, denying the service.

In accordance with another aspect of the present invention, there is provided a method for protecting from a denial-of-service attack, applicable to a server authentication system in which a client uses as the challenge to the server a discrete exponentiation g^{T}^{_{A}} modulo a prime number p, a private key and a corresponding public key of a server are respectively b and g^{b}, and the ciphertext of the client's challenge using the public key of the server is g^{br}^{_{A}}, the method including the steps of; (a) the server's sending a random number r_{B} to the client; (b) the client's sending, back to the server, x and y values computed by using the random number sent to the client and the client's own random number r_{A} as; x=(g^{b})^{r}^{_{A}}^{+r}^{_{B}} where b is the private key of the server and g^{b} is the public key of the server, and y=h(g^{r}^{_{A}}) where h represents a hash function; (c) comparing x and y from the client with y¹ as follows; y¹=h(x^{b-1}g^{-r}^{_{B}}) where h represents the hash function; (d) if y matches y¹, providing a service to the client, and, otherwise, denying the service.

In accordance with another aspect of the present invention, there is provided, in a communication system having a large capability processor in which a client sends a server a ciphertext of a random number encrypted under the public key of the server to authenticate the server, a computer readable medium for recording a program for implementing the functions of: (a) at the server, generating a random number r_{B} in response to a service request from a client and sending the random number to the client; (b) at the server, receiving the ciphertext which is produced by the client based on the random number r_{B} sent to the client and a random number r_{A} of the client; (c) at the server, recovering the random number r_{B} from the ciphertext received from the client and comparing the recovered random number with the random number sent to the client; and (d) if the random numbers match at the step (c), providing the service, and, otherwise, denying the service.

In accordance with another aspect of the present invention, there is provided, in a server authentication system having a large capability processor, in which a client uses a disrecte exponentiation g^{r}^{_{B}} as a random challenge to a server, a private key and a public key of the server are respectively b and g^{b}, and a ciphertext of the client's challenge using the public key of the server is g^{br}^{_{A}}, a computer readable medium for recording a program for implementing the functions of: (a) at the server, sending a random number to a client; (b) at the server, receiving x and y values which the client computed by using the random number from the server as: x=(g^{b})^{r}^{_{A}}^{+r}^{_{D}} where b is the private key of the server and g^{b} is the public key of the server, and y=h(g^{r}^{_{A}}) where h represents a hash function; (c) at the server, comparing y from the client with y¹ as follows: y¹=h(x^{b}^{^{A}}g^{-r}^{_{B}}); and (d) if y and y¹ providing a service to the client, and, otherwise, denying the service.

### BRIEF DESCRIPTION OF THE DRAWINGS

The above and other objects and features of the instant invention will become apparent from the following description of preferred embodiments taken in conjunction with the accompanying drawings, in which:

FIG. 1 is a diagram of an embodiment of a procedure for protecting from denial-of-service attack in authentication protocols using public key encryption in accordance with the present invention;

FIG. 2 shows a diagram of an embodiment of a procedure for generating random numbers in accordance with the present invention;

FIG. 3 offers a diagram of another embodiment of a procedure for protecting from denial-of-service attack in authentication protocols using public key encryption in accordance with the present invention; and

FIG. 4 presents a diagram of an embodiment of a procedure for protecting from denial-of-service attack in authentication protocols using particular public key encryption in accordance with the present invention.

### PREFERRED EMBODIMENT OF THE INVENTION

Hereinafter, preferred embodiments of the present invention will be described in detail with reference to the accompanying drawings.

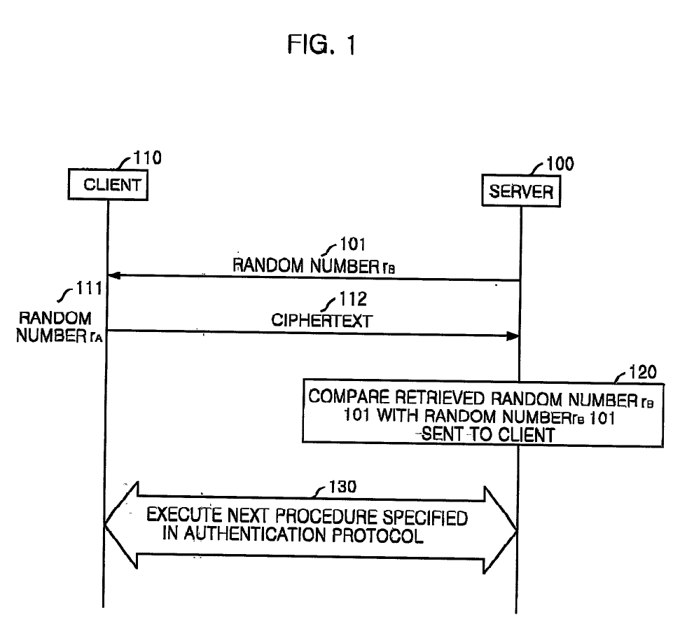

FIG. 1 is a diagram of an embodiment of a procedure for protecting from denial-of-service attack in authentication protocols using public key encryption in accordance with the present invention.

The basic concept of the present invention is that the client is require to encrypt a random number received from the server as well as its own random number. This is quite an extraordinary usage of random number encryption in public key based authentication protocols. That is, in the present invention, an additional random number is used to check whether the client (system) generated a ciphertext under a protocol. When the client (system) encrypts and sends only its own random number to the server, the random number decrypted at the server can provide no information about the procedure of the ciphertext of the client (system) because the random number has no meaning. On the contrary, if the random number of the server is included the ciphertext from the client (system), the random number of the server is included in the decrypted result so that the server can conclude that the ciphertext is generated according to the correct procedure.

As shown in FIG. 1, the server 100 generates a random number r_{B} 101 and sends it to the client (system) 110.

The client (system) 210, upon receiving the random number r_{B} 101 from the server 100, generates a random number r_{A} 111 and encrypts the two random numbers r_{B} 101 and r_{A} 111 using the server's public key K_{B}, and then the resulting ciphertext 112 is sent to the server 100.

The server 100 decrypts the ciphertext 112 received from the client (system) 110 and retrieves the random numbers r_{B} 101 and r_{A} 111 from the ciphertext 112.

The server 100 compares the retrieved value of the random number r_{B} 101 with the value of the random number r_{B} 101 which the server 100 sent to the client 110. The value of the retrieved r_{B} and the value of r_{B} 101 which has been sent to the client is to be matched. Otherwise, the received ciphertext 112 is not produced by the proper protocol but is simply a garbage value sent by a malicious attacker.

If the value of the retrieved r_{B} and the value of r_{B} 101 which has been sent to the client match, a next procedure specified in the authentication protocol to which the present invention is applied is executed.

On the other hand, without using this kind of countermeasure, there is no way for the server 100 to check whether the received ciphertext 112 is really the result of proper cryptographic computation, and hence even for a garbage value attack, the server 100 will execute a public key computation for decryption, send the subsequent message to the attacker, and finally will result in a state of the session left open waiting the next message from the attacker. Of course, the attacker will not send the response message, and this session spends resources of the server until time out.

By using the method as described above, such a waste of session resources can be saved.

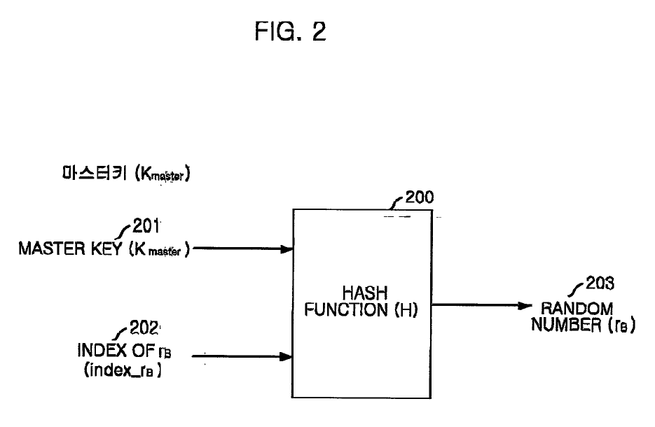

FIG. 2 shows a diagram of an embodiment of a procedure for generating random numbers in accordance with the present invention.

The random number r_{B} can even be generated in a way that enables the server to achieve more robustness against denial-of-service attacks.

Usually, after the delivery of r_{B} to the client (system) 110, the server 100 is expected to assign a unique session to the service requesting client (system) 110. In this situation, the value of the random number r_{B} 101 is uniquely related to the corresponding session. The value of the random number r_{B} 101 is stored in a memory within the server to be compared with the received value of random number r_{B} from the client (system) 110.

The problem of the method is very similar to that of TCP/IP environment that leads to the notorious SYN flooding attacks. This problem can be avoided as follows.

That is, the server delays the assignment of the system resources to the client until the ciphertext is proven to be correctly produced, i.e., the server should not assign a particular value of r_{B} with a particular client before the client sends the correct ciphertext.

The particular value of r_{B} is generated as follows.

As shown in FIG. 2, the random number r_{B} is produced by running a hash function H 200 with a master key Kₘₐₛₜₑᵣ 201 and an index index_r_{B} 202 of the random number r_{B} as the inputs.

Here, the index index_r_{B} 202 of the random number r_{B} runs from 0 to M−1 where M is a preset parameter whose value is a sufficiently larger number and can be freely chosen by the server system.

That is, when a new value of the random number r_{B} is generated, the server runs the hash function with the master key Kₘₐₛₜₑᵣ 201 and the index index_r_{B} 202, of the random number r_{B}, as the inputs. And the hash result will be used as the value of the random number r_{B}.

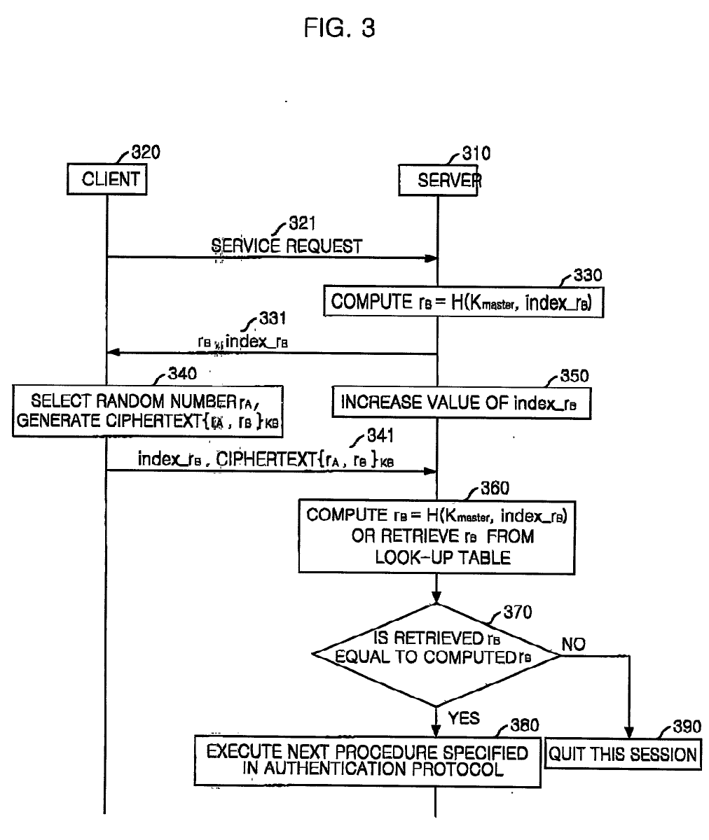

FIG. 3 offers a diagram of an embodiment of a procedure, using the methods shown in FIG. 1 and FIG. 2, for protecting from denial-of-service attack on authentication protocols using public key encryption in accordance with the present invention.

At first, in response to a service request 321 from the client (system) 320, the server 310 generates a new value of the random number r_{B} 330 by an operation as follows:

r_{B}=H(Kₘₐₛₜₑᵣ, index_r_{B})

And then, the server 310 sends 331 the generated value of the random number r_{B} 330 and the index index_r_{B} of the random number r_{B} to the client (system) 331 and increments 350 the index index_r_{B} of the random number r_{B}.

On receipt of the random number r_{B} and the index_r_{B} of the random number r_{B}, the client (system) 320 generates its own random number r_{A}, and encrypts r_{A} and r_{B} under the public encryption key K_{B}. Here, the ciphertext in which r_{A} and r_{B} are encrypted under the public encryption key K_{B} is represented as {r_{A},r_{B}}_{K}_{_{A}}.

The client (system) 320 sends 341 the ciphertext {r_{A},r_{B}}_{K}_{_{B}} with the random number r_{B} and the index index_r_{B} or the randoms number r_{B} to the server 310.

When the server 320 receives the ciphertext {r_{A},r_{B}}_{K}_{_{B}} from the client (system) 320, using the received value of the index index_r_{B} of the random number r_{B}, it retrieves 360 from a look-up table or, alternatively, using the equation r_{B}=H(Kₘₐₛₜₑᵣ,index_r_{B}), re-computes the corresponding value of r_{B}.

The server 310 decrypts 370 the received ciphertext {r_{A},r_{B}}_{K}_{_{B}} and retrieves the value of r_{B} which is compared with the value of r_{B} that was retrieved or recomputed.

If both values match, the server 310 is assured 380 that the client (system) 320 has formed honestly and sent the ciphertext {r_{A},r_{B}}_{K}_{_{B}}, which leads the server to the next step specified in the authentication protocol.

On the other hand, if the match fails, the server 310 may conclude that the client (system) 320 sent a bogs message which has nothing to do with the correct cryptographic operation to compute the ciphertext {r_{A},r_{B}}_{K}_{_{B}}, i.e., the client (system) 320 is trying denial-of-service attack. Therefore, the server stops 390 this session.

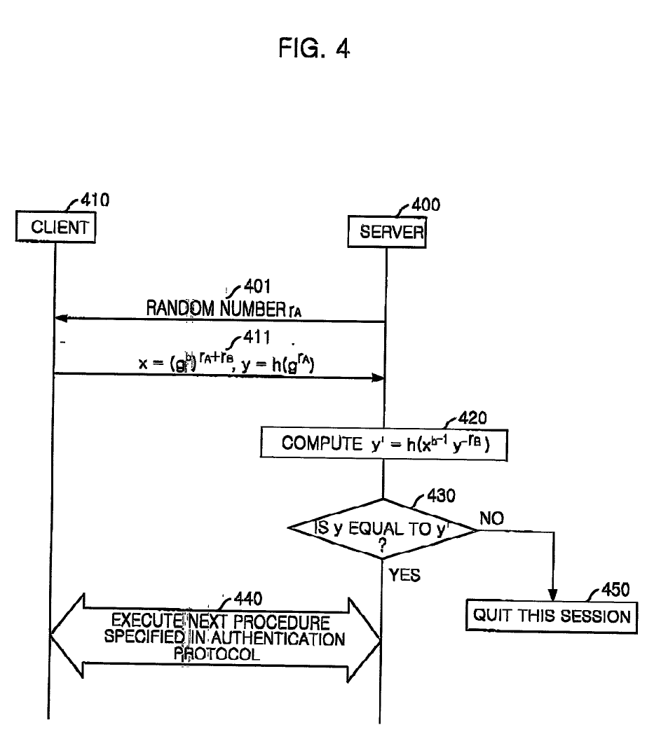

FIG. 4 presents a diagram of an embodiment of a procedure for defeating denial-of-service attack on authentication protocols using special public key encryption in accordance with the present invention.

In a particular encryption based on discrete log cryptographly, the encryption of the client's random number (here, g^{r}^{_{A}} instead of r_{A}) can be computed as g^{br}^{_{A}} where g is a generator element of a finite cyclic group agreed between the client (system) and the server, and b and g^{b} are the private key and the public key of the server, respectively. This particular form of encryption cannot easily accommodate the method as described with reference to FIG. 1. This difficulty can be solved as follows.

The server 400 sends a random number r_{B} 401 to the client (system) 410 requesting a service.

The client (system) 410 receiving the random number r_{B} 401 computes 411 x=(g^{b})^{r}^{_{A}}^{+r}^{_{B}} and y=h(g^{r}^{_{A}}), and sends both values to the server 400, where h is a hash function agreed between the server 400 and the client (system) 410.

The server 400 receiving x and y computes 420 y¹=h(x^{b}^{⁻¹}g^{-r}^{_{B}}) and compares 430 the result with the received value of y.

If both values are the same then the server 400 may conclude that the client 410 has sent honestly computed the required public key encryption. Therefore, the server 400 can go to 440 the next step specified in authentication protocol.

Otherwise, the mismatch indicates that the client 410 is trying the denial-of-service attack by sending a bogus message, and therefore the server stops 450 the session.

In this method, there is no additional public key computation required in the client (system) side while the computation of g^{-r}^{_{B}} is to be computed by the server 300. However, this computation can always be handled offline not online. Accordingly, in practical operations, the generation of r_{B} and the computation of g^{-r}^{_{B}} can be processed with batch computation. One exponentiation needed to compute the discrete exponentiation x^{b}^{⁻¹} in the computation of y¹=h(x^{b}^{^{-d}}g^{-r}^{_{B}}) is unavoidable because the server requires the power computation (g^{br}^{_{A}})^{b}^{⁻¹}=g^{r}^{_{A}} to retrieve g^{r}^{_{A}} even when the method of the present invention is not reemployed. Accordingly, the intermediate value x^{b}^{⁻¹}g^{r}^{_{B}}=g^{r}^{_{A}} does not require any additional discrete exponentiation.

The method as described above is applicable to any protocol in which the client authenticates the server by using the public key encryption.

As described above, the method of the present invention can be implemented as a program which can be recorded at a computer readable medium.

As described above, the present invention gives robustness against the denial-of-service to the authentication protocol itself, loads no additional public key computation, and is applicable to any authentication protocol in which the client authenticates the server by encrypting the client's random number with the public key of the server.

Although the preferred embodiments of the invention have been disclosed for illustrative purpose, those skilled in the art will be appreciate that various modifications, additions and substitutions are possible, without departing from the scope and spirit of the invention as disclosed in the accompanying claims.

What is claimed is:

1. A method for defeating a denial-of-service attack, for use in a communication system in which a client sends a ciphertext of a random number chosen by the client encrypted under a public key of a server to authenticate a server, the method comprising the steps of:
(a) at the server, generating a random number r_{B} in response to a service request from a client and sending the random number to the client;
(b) at the server, receiving the ciphertext produced by using the random number r_{B} from the client and a random number r_{A} of the client;
(c) at the server, recovering a random number r_{B} from the ciphertext received from the client and comparing the recovered random number with the random number sent to the client; and
(d) if the random numbers match at the step (c), providing the service, and, otherwise, denying the service.

2. The method as received in claim 1, wherein, at the step (a), the random number r_{B} obtained by an equation r_{B}=H(Kₘₐₛₜₑᵣ,index_r_{B}) where H is a hash function, Kₘₐₛₜₑᵣ is a secret master key and index_r_{B} is an index parameter for the random number.

3. A method for defeating denial-of-service attack, applicable to a server authentication system in which a client uses a discrete exponentiation g^{r}^{_{A}} as a random challenge the server a private key and a public key of a server are respectively b and g^{b}, and the ciphertext of the client's challenge using the public key of the server is g^{br}^{_{A}}, the method comprising the steps of:
(a) at the server, sending a random number r_{A} to a client;
(b) at the server, receiving x and y values which the client computed by using the random number from the server as:
x=(g^{b})^{r}^{_{A}}^{+r}^{_{b}}
where b is the private key of the server and g^{b} is the public key of the server, and
y=h(g^{r}^{_{A}})
where b represents a hash function;
(c) comparing y from the client with y¹ as follows:
y¹=h(x^{b}^{⁻¹}g^{-r}^{_{B}}); and
(d) if y and y¹ match, providing a requested service to the client, and, otherwise, denying the service the client.

4. In a communication system having a large capability processor in which a client sends a server a ciphertext of a random number encrypted under a public-key of the server to authenticate the server, a computer readable medium for recording a program for implementing the functions of:
(a) at the server, generating a random number r_{B} in response to a service request from a client and sending the random number to the client;
(b) at the server, receiving the ciphertext which is produced by the client based on the random number r_{B} sent to the client and a random number r_{A} of the client;
(c) at the server, recovering the random number r_{B} from the ciphertext received from the client and comparing the recovered random number with the random number sent to the client; and
(d) if the random numbers match at the step (c), providing the service, and, otherwise, denying the service.

5. In a server authentication system having a large capability processor, in which a client uses a discrete exponentiation g^{r}^{_{A}} as a random challenge to a server, a private key and a corresponding public key of the server are respectively b and g^{b}, and a ciphertext of the client's challenge using the public key of the server is g^{br}^{_{A}}, a computer readable medium for recording a program for implementing the functions of:
(a) at the server, sending a random number to a client;
(b) at the server, receiving x and y values which the client computed by using the random number from the server as:
x=(g^{b})^{r}^{_{A}}^{+r}^{_{A}}
where b is the private key of the server and g^{b} is the public key of the server, and
y=h(g^{r}^{_{A}})
where h represents a hash function;
(c) at the server, comparing y from the client with y¹ as follows:
y¹=h(x^{b}^{⁻¹}g^{-r}^{_{A}}); and
(d) if y and y¹ match, providing a service to the client, and, otherwise, denying the service.
